(19) United States
(12) Patent Application Publication
(10) Pub. No.: US 2018/0089329 A1
(43) Pub. Date: Mar. 29, 2018

(54) METHOD AND DEVICE FOR MANAGING INDEX

(71) Applicant: EMC IP Holding Company LLC, Hopkinton, MA (US)

(72) Inventors: Kun Wu Huang, Shanghai (CN); Charlie Chen, Shanghai (CN); Winston Lei Zhang, Shanghai (CN); Jingjing Liu, Shanghai (CN); Duke Dai, Shanghai (CN)

(21) Appl. No.: 15/711,172

(22) Filed: Sep. 21, 2017

(30) Foreign Application Priority Data
Sep. 23, 2016 (CN) CN201610848777.2

(51) Int. Cl. G06F 17/30

(52) U.S. Cl. CPC G06F 17/30946; G06F 17/30967; G06F 17/30011

(57) ABSTRACT

Embodiments of the present disclosure provide a method and device for managing index. For example, there is provided a method, comprising: obtaining a first index term in a first index, the first index term corresponding to a first index content in the first index, the first index content indicating a position of the first index term in a document; generating a reading of the first index term; and adding the reading as a second index term into a second index, the reading corresponding to a second index content indicating the first index term. Corresponding device and computer program product are also provided.

### RELATED APPLICATIONS

This application claim priority from Chinese Patent Application Number CN201610848777.2, filed on Sep. 23, 2016 at the State Intellectual Property Office, China, titled “A METHOD AND DEVICE FOR MANAGING INDEX” the contents of which is herein incorporated by reference in its entirety.

### FIELD

Embodiments of the present disclosure generally relate to document index, and more specifically, to a method and device for managing index.

### BACKGROUND

For example, in a search field such as an enterprise search field, end-users expect to provide query terms to find expected documents. However, the end-users sometimes cannot remember or may don't know the exact terms exist in those documents. For example, the end-users would like to search “sheperd” whereas the exact term in the document is “sheeperd.” Thus, when the end-users provide a query term “sheperd,” it is impossible to find the expected documents. In this case, the requirement for inputting the exact term causes considerable inconvenience for the end-users.

### SUMMARY

To solve the above and other potential problems, embodiments of the present disclosure provide a method and device for managing index.

According to a first aspect of the present disclosure, there is provided a method for managing index, the method comprises: obtaining a first index term in a first index, the first index term corresponding to a first index content in the first index, the first index content indicating a position of the first index term in a document; generating a reading of the first index term; and adding the reading as a second index term into a second index, the reading corresponding to a second index content indicating the first index term.

In some embodiments, adding the reading as a second index term into a second index comprises: in response to the reading matching an existing index term in the second index, appending the second index content indicating the first index term to the existing index term.

In some embodiments, adding the reading as a second index term into a second index comprises: in response to the reading mismatching all existing index terms in the second index, creating the second index term and the second index content.

In some embodiments, the second index excludes field information of the document.

In some embodiments, the method further comprises in response to a predefined condition related to the number of operations on the document being satisfied, re-creating the second index.

In some embodiments, the method further comprises generating a reading for a received query term; in response to the reading of the query term matching a third index term in the second index, generating an expanded query term based on an index content corresponding to the third index term; and performing a query on the first index by using the expanded query term.

According to a second aspect of the present disclosure, there is provided an electronic device. The device comprises at least one processing unit and at least one memory coupled to the at least one processing unit and storing instructions executed by at least one processing unit. The instructions, when executed by the at least one processing unit, perform acts include: obtaining a first index term in a first index, the first index term corresponding to a first index content in the first index, the first index content indicating a position of the first index term in a document; generating a reading of the first index term; and adding the reading as a second index term into a second index, the reading corresponding to a second index content, the second index content indicating the first index term.

In some embodiments, adding the reading as a second index term into a second index comprises: in response to the reading matching an existing index term in the second index, appending the second index content indicating the first index term to the existing index term.

In some embodiments, adding the reading as a second index term into a second index comprises: in response to the reading mismatching all existing index terms in the second index, creating the second index term and the second index content.

In some embodiments, the second index excludes field information of the document.

In some embodiments, the acts further include: in response to a predefined condition related to the number of operations on the document being satisfied, re-creating the second index.

In some embodiments, the acts further include: generating a reading for a received query term; in response to the reading of the query term matching a third index term in the second index, generating an expanded query term based on an index content corresponding to the third index term; and performing a query on the first index by using the expanded query term.

According to a third aspect of the present disclosure, there is provided a computer program product tangibly stored on a non-transient computer readable medium and including machine executable instructions. The instructions, when executed, cause a machine to execute steps of the method described according to the first aspect of the present disclosure.

It will be understood through the following description that the present disclosure provides a solution for supporting the use of reading query in a search engine. The objective of the present disclosure is enabling the end-users to find expected documents using similar readings, to improve search quality and efficiency.

The summary is provided to introduce selections of concepts in a simple manner and the concepts will be further described in the following detailed description of embodiments. The summary bears no intention to identify key or essential features of the present disclosure, or to limit the scope of the present disclosure.

### BRIEF DESCRIPTION OF THE DRAWINGS

Through the following detailed description of the example embodiments of the present disclosure with reference to the accompanying drawings, the above and other objectives, features, and advantages of the present disclosure will become more apparent. In the example embodiments of the present disclosure, the same reference signs usually represent the same components:

FIG. 1 is a block diagram of a system for managing index according to embodiments of the present disclosure;

FIG. 2 is a flow chart of a method for managing index according to embodiments of the present disclosure;

FIG. 3 is a flow chart a method for utilizing a second index according to embodiments of the present disclosure;

FIG. 4 is a schematic block diagram of an example device 400 for implementing embodiments of the present disclosure.

### DETAILED DESCRIPTION OF EMBODIMENTS

Preferred embodiments of the present disclosure will be described in more detail with reference to the drawings. Although the drawings present the preferred embodiments of the present disclosure, it should be understood that the present disclosure can be implemented in various manners and should not be limited by the embodiments disclosed herein. On the contrary, the embodiments are provided for a more thorough and complete understanding of the present disclosure, so as to fully convey the scope of the present disclosure to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The terms “one example embodiment” and “an example embodiment” are to be read as “at least one example embodiment.” The term “a further embodiment” is to be read as “at least one further embodiment.” The terms “first” and “second” and so on can represent different or identical objects. Other explicit and implicit definitions may be included in the following text.

Conventionally, a plurality of technologies have been proposed to improve search quality by allowing end-users to perform a non-exact query. The technologies include for example:
lemmatizalion, which normalizes the query term to a lemma form;
stemming, which get the stem of the query term;
wildcard query, in which * represents 0 to any number of characters in the query term, ? represents 0 or 1 character in the query term, and + represents 1 to any number of characters;
fuzzy query, which uses the edit distance to get terms similar to the query term;
regular expression query, which uses the regular expression to get the query term; and
thesaurus query, which uses the thesaurus to expand the query term.

However, the way of writing of the documents by end-users in different regions may have tiny difference. For example, American English and British English have some tiny differences regarding the same word, and Traditional Chinese and Simplified Chinese use different characters to present the same meaning. Additionally, the end-users may incorrectly spell some characters in the documents or in the query terms. In these cases, conventional technologies cannot effectively improve search quality.

To at least partially solve the above and other potential problems, example embodiments of the present disclosure present a solution for managing index. In this solution, an index term (also referred to as first index term) in a first index is obtained. The first index can be the inverted index or any other index for locating the position of the index term in the document. The first index term corresponds to a first index content in the first index, and the first index content indicates the position of the first index term in the document. Additionally, a reading of the first index term is generated, and the reading is added as an index term (also referred to as second index term) in the second index to the second index, such that a second index content corresponding to the reading indicates the first index term. Furthermore, a reading for a received query term is generated, and in response to the reading of the query term matching an index term (also referred to as third index term) in the second index, an expanded query term is generated based on an index content corresponding to the third index term, so as to perform a query on the first index by using the expanded query term.

For instance, when the end-user provides a query term “sheperd,” a reading “XPRT” for the query term “sheperd” can be generated. Based on the generated reading, a second index may be used to expand the query term as query terms “sheperd,” “sheeperd” and “shepard” having similar readings, such that the expected documents containing the exact term “sheeperd” can be found even if the user only provides the query term “sheperd.” In this way, by generating the second index based on the reading, the end-user can try to find the expected documents through similar readings as long as they know the reading of the query term. Therefore, a solution of using reading query in full-text search engine via reading-based index to improve search quality and efficiency is presented.

For the convenience of description, hereinafter, the inverted index may be used as an example of the first index, and the reading index may be used as an example of the second index. However, it should be appreciated that this is only for facilitating description and bears no intention to limit the present disclosure. The ideas and spirits of the present disclosure are suitable for any currently known or to be developed index technologies.

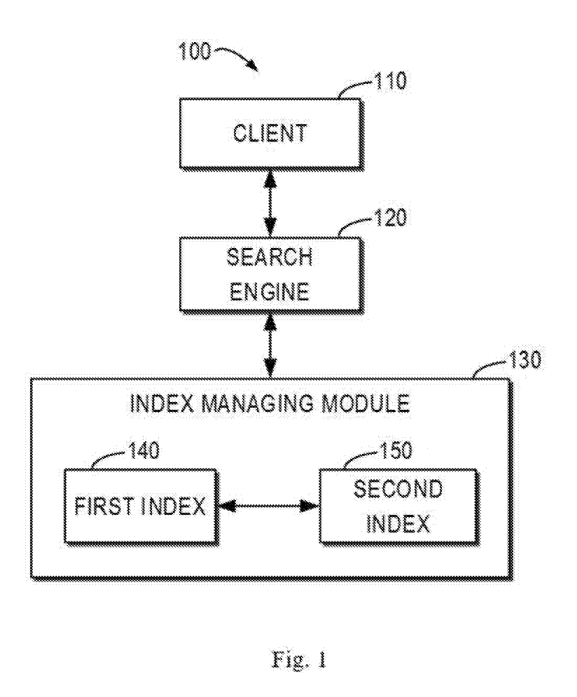

FIG. 1 is a block diagram of a system 100 for managing index according to embodiments of the present disclosure. It should be understood that the structure and function of the system 100 are described for the purpose of examples rather than suggesting any limitations on the scope of the present disclosure. Embodiments of the present disclosure can be embodied in different structures and/or functions.

As shown in FIG. 1, the system 100 can include: a client 110, a search engine 120 and an index managing module 130. The client 110 can send to the search engine 120 a request for querying (or searching) a document. The search engine 120 invokes the index managing module 130 to respond to the request from the client 120. For example, upon receiving a query request for a given query term (or keyword) from the client 110, the search engine 120 invokes the index managing module 130 for performing a query, and provides the query result to the client 110. In some embodiments, the query result can indicate the position of the query term in the document. Alternatively, the query result can indicate the document in which the query term exists, or includes a list of documents containing the query term.

The index managing module 130 can include a first index 140 and a second index 150. The first index 140 can be the inverted index or any other index for locating the position of the index term in the document. The index content corresponding to the index term in the first index 140 can indicate the position of the index term in the document. Alternatively, the index content corresponding to the index term in the first index 140 can indicate the document where the index term exists. In some embodiments, the index term in the first index 140 can be a word. Alternatively, the index term in the first index 140 is not limited to the word, and can also be a phrase, a sentence, a paragraph, a document or the like.

The second index 150 can be a reading-based index created using the existing first index 140. In some embodiments, the index term in the second index 150 can be a reading. The second index 150 can be created prior to performing the query to support the reading query. The second index 150 can be stored as a file supporting querying a reading to get a list of index content. In this case, the reading as the index term in the second index 150 can be organized into a list, which is stored in data structures such as B-Tree or Trie tree. The index term in the second index 150 can be linked to a list of index content as follows:

Index term 1->index content 1, index content 2, index content 3 . . .
Index term 2->index content 4, index content 5, index content 6 . . .

The second index 150 created in the above structure can support the addition, update or deletion of the index contents according to document processing. In addition, in comparison with the first index 140, the index term in the second index 150 will not be linked to an excessive number of index contents.

When the second index 150 is created, the client 110 can submit a query to the search engine 120. The search engine 120 can invoke the index managing module 130 to access the second index 150 to perform the query term expansion. The expanded query term is then used to access the first index 140. In this manner, the client 110 can find the expected document using the reading, to improve search quality and efficiency.

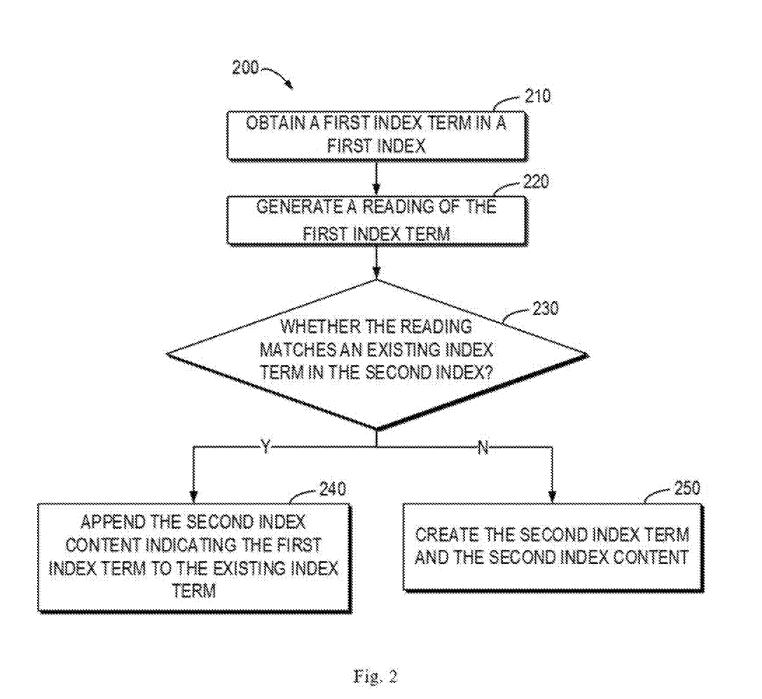

FIG. 2 is a flow chart of a method 200 for managing index according to embodiments of the present disclosure. For example, the method 200 can be executed by the index managing module 130 shown in FIG. 1. It should be understood that the method 200 can further comprise additional steps not shown and/or can omit the steps shown, and the scope of the present disclosure is not restricted in this regard.

At 210, the index managing module 130 can obtain a first index term in the first index 140. The first index content corresponding to the first index term in the first index 140 can indicate the position of the first index term in the document.

At 220, the index managing module 130 can generate a reading of the first index term. In some embodiments, the index managing module 130 can generate the reading of the first index term using a reading generation model, which can be for example Beider-Morse Phonetic Matching, Double Metaphone, pinyin4j, jpinyin or tinypinyin and so on. In some embodiments, as readings are language specific, the index managing module 130 can detect the language of the first index term prior to generating the reading, such that a language specific reading generation model is utilized for different languages to generate readings.

For example, when the first index term is detected to be English, the above Beider-Morse Phonetic Matching or Double Metaphone is used to generate the reading. For example, when the first index term is “sheperd,” the reading of the first index term “sheperd” can be generated as “XPRT”, whereas when the first index term is “name,” the reading of the first index term “name” can be generated as “NM.” However, when the first index term is detected to be Chinese, the above pinyin4j, jpinyin or tinypinyin can be used to generate the reading. For instance, when the first index term is “ [symbol] (common),” the reading of the first index term “ [symbol] ” can be generated as “changjian.”

At 230, the index managing module 130 can determine whether the generated reading matches the index term in the second index 150. When the reading matches an existing index term in the second index 150, the index managing module 130 can append a second index content indicating the first index term to the existing index term at 240. For example, assuming that the first index term is “sheperd,” and the second index 150 is as follows:
XPRT->sheeperd, shepard

The index managing module 130 can determine that the reading “XPRT” generated for the first index term “sheperd” at 220 matches the existing index term “XPRT” in the second index 150. The index managing module 130 can subsequently append the second index content indicating the first index term “sheperd” to the existing index term “XPRT,” changing the second index 150 into:
XPRT->sheeperd, shepard, sheperd

When the reading mismatch all of the existing index terms of the second index 150, the second index term and the second index content are created at 250. For instance, assuming that the first index term is “name,” and the second index 150 is as follows:
XPRT->sheeperd, shepard, sheperd

The index managing module 130 can determine that the reading “NM” generated for the first index term “name” at 220 does not match the existing index term “XPRT” of the second index 150. The index managing module 130 can subsequently use the reading “NM” of the first index term to create a second index term, and use the first index term “name” to create the second index content, such that the second index 150 is changed into:
XPRT->sheeperd, shepard, sheperd
   NM->name

In some embodiments, because the field information of the document is not directly used for query, the index managing module 130 can take no account of the field information of the document when creating the second index 150 to further improve search efficiency. Alternatively, the index managing module 130 can consider the field information of the document upon creating the second index 150. The field information is metadata fields, such as subject matter, author, keyword, creation date, document type, and comments of the document.

In some embodiments, the index managing module 130 can update the second index 150 during the processing of the document. For example, when a new document is submitted to the system 100, the index managing module 130 can automatically add new index terms or index contents to the second index 150, to ensure that the second index 150 is expanded using the new index terms or index contents. Alternatively, when a new document is submitted to the system 100, the index managing module 130 may not expand the second index 150, or may expand the second index 150 according to the request from the client 110.

Furthermore, when the document is deleted from the system 100, the index managing module 130 may not delete the existing index terms or index contents related to the deleted document from the second index 150, to reduce the possible deletion or addition operations of the index terms or index contents. As an alternative, the index managing module 130 can automatically delete the existing index terms or index contents related to the deleted document from the second index 150, or delete the index terms or index contents from the second index 150 based on the request from the client 110.

It will be appreciated that documents may be added, deleted or updated with the processing of the documents. To cope with this situation, in some embodiments, the index managing module 130 can re-create a second index 150. For example, the index managing module 130 can regularly re-create the second index 150. Alternatively, the index managing module 130 can re-create the second index 150 based on the request from the client 110, or set a document processing counter, such that the second index 150 is recreated when the number of addition, deletion or update of the documents exceeds a predefined threshold.

Through method 200, the created second index 150 can be easily implemented in the system 100, and can be easily unloaded from the system 100 when the second index 150 is not required. Furthermore, by generating the reading-based second index 150, the reading query can be easily implemented in the system 100 to improve search quality and efficiency.

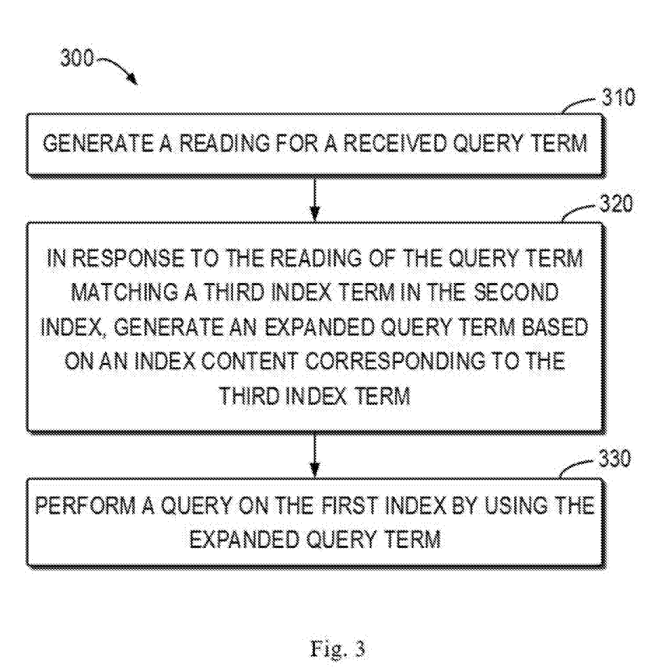

FIG. 3 is a flow chart of a method 300 for utilizing the second index 150 created according to the method 200. For example, the method 300 can be executed by the index managing module 130 shown in FIG. 1. It should be appreciated that the method 300 can further comprise additional steps not shown and/or can omit the steps shown, and the scope of the present disclosure is not restricted in this regard.

At 310, the index managing module 130 can generate a reading for a received query term. In some embodiments, the client 110 can send a request for querying a document to the search engine 120 through the query term. The search engine 120 invokes the index managing module 130 and provides the query term to the index managing module 130.

In some embodiments, the index managing module 130 can tokenize the query term after receiving it. The query term can be tokenized in a way corresponding to the index term in the first index 140. For example, when the index term in the first index 140 is a word, the index term is tokenized into a word. After receiving the query term “name sheperd”, the index managing module 130 can tokenize the query term “name sheperd” into words “name” and “sheperd.” The index managing module 130 then can generate readings for the tokenized query terms, respectively. For example, the index managing module 130 can generate a reading “NM” of the query term “name” and a reading “XPRT” of the query term “sheperd.” Alternatively, the index managing module 130 may not tokenize the query term.

At 320, the index managing module 130 can determine whether the reading of the query term matches the index term in the second index 150. In response to the reading of the query term matching an index term (also referred to as third index term) of the second index 150, the index managing module 130 can generate an expanded query term based on an index content corresponding to the third index term. For example, assuming that the index managing module 130 receives a query term “sheperd,” and the second index 150 contains the following index term and index contents:
XPRT->sheeperd, shepard, sheperd

The index managing module 130 can determine that the reading “XPRT” of the query term “sheperd” matches the index term “XPRT” in the second index 150, such that the index managing module 130 can generate expanded query terms “sheeperd,” “shepard” and “sheperd” based on the index contents “sheeperd,” “shepard” and “sheperd” corresponding to the index term “XPRT.” In other words, the index managing module 130 can expand the initial query term “sheperd” into the query terms “sheeperd,” “shepard” and “sheperd.”

At 330, the index managing module 130 can perform a query on the first index 140 by using the expanded query term. For example, the index managing module 130 can locate respective positions of the query terms “sheeperd,” “shepard” and “sheperd” based on the first index 140. The index managing module 130 can then return a query result to the search engine 120, and thus providing the query result to the client 110.

In some embodiments, the index managing module 130 can disable the second index 150. For instance, the index managing module 130 can disable the second index 150 based on a request from the client 110. In this case, the index managing module 130 will not use the second index 150 to perform a reading-based expansion for the query term. As an alternative, when other query techniques are employed, the index managing module 130 can disable the second index 150. For example, when the above query techniques, such as lemmatization, stemming, wildcard query, fuzzy query, regular expression query, thesaurus query or the like, are employed, the index managing module 130 can disable the second index 150.

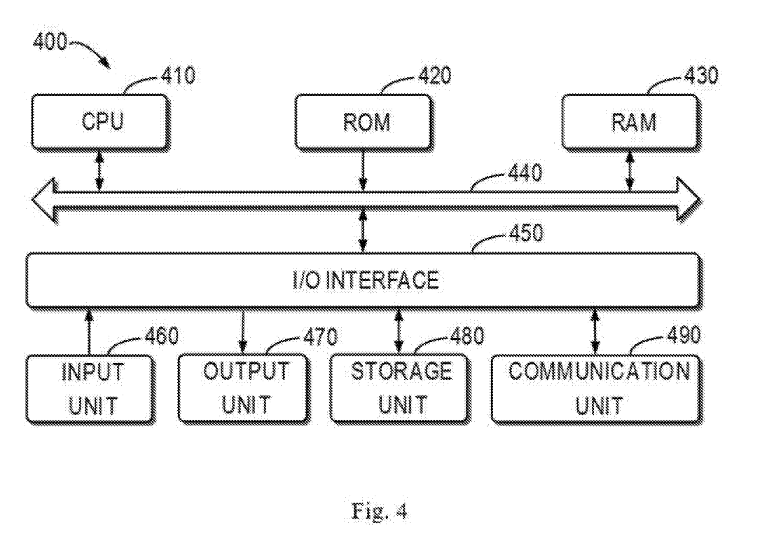

FIG. 4 is a schematic block diagram of an example device 400 for implementing embodiments of the present disclosure. As indicated, the device 400 comprises a central processing unit (CPU) 401, which can execute various appropriate actions and processing based on the computer program instructions stored in a read-only memory (ROM) 402 or the computer program instructions loaded into a random access memory (RAM) 403 from a storage unit 408. The RAM 403 also stores all kinds of programs and data required by operating the storage device 400. CPU 401, ROM 402 and RAM 403 are connected to each other via a bus 404, to which an input/output (I/O) interface 405 is also connected.

A plurality of components in the device 400 is connected to the I/O interface 405, comprising: an input unit 406, such as keyboard, mouse and the like; an output unit 407, such as various types of display, loudspeakers and the like; a storage unit 408, such as magnetic disk, optical disk and the like; and a communication unit 409, such as network card, modem, wireless communication transceiver and the like. The communication unit 409 allows the device 400 allows the device 400 to exchange information/data with other devices through computer networks such as Internet and/or various telecommunication networks.

Each procedure and processing described above, such as methods 200 and 300, can be executed by a processing unit 401. For example, in some embodiments, the methods 200 and 300 can be implemented as computer software programs, which are tangibly included in a machine-readable medium, such as storage unit 408. In some embodiments, the computer program can be partially or completely loaded and/or installed to the device 400 via ROM 402 and/or the communication unit 409. When the computer program is loaded to RAM 403 and executed by CPU 401, one or more steps of the above described methods 200 and 300 are implemented. Alternatively, CPU 401 can also be configured to execute the above described methods 200 and 300 via any suitable manners (such as by means of firmware).

It can be seen from the above description that the solution of the present disclosure is suitable for the application performing a query using the reading in a full-text search system. The embodiments of the present disclosure generate a reading-based second index by using a first index such as the inverted index, such that the end-users can perform a non-exact query using similar readings to find expected documents, and thus improving search quality and efficiency.

The present disclosure may be a method, a device, a system and/or a computer program product. The computer program product can include a computer-readable storage medium loaded with computer-readable program instructions thereon for executing various aspects of the present disclosure.

The computer-readable storage medium can be a tangible device capable of holding and storing instructions used by the instruction-executing device. The computer-readable storage medium can be, but not limited to, for example electrical storage devices, magnetic storage devices, optical storage devices, electromagnetic storage devices, semiconductor storage devices or any random appropriate combinations thereof. More specific examples (non-exhaustive list) of the computer-readable storage medium comprise: portable computer disk, hard disk, random-access memory (RAM), read-only memory (ROM), erasable programmable read-only memory (EPROM or flash), static random access memory (SRAM), portable compact disk read-only memory (CD-ROM), digital versatile disk (DVD), memory stick, floppy disk, mechanical coding device, such as a punched card storing instructions or an emboss within a groove, and any random suitable combinations thereof. The computer-readable storage medium used herein is not interpreted as a transient signal itself, such as radio wave or other freely propagated electromagnetic wave, electromagnetic wave propagated through waveguide or other transmission medium (such as optical pulses passing through fiber-optic cables), or electric signals transmitted through electric wires.

The computer-readable program instructions described here can be downloaded from the computer-readable storage medium to various computing/processing devices, or to external computers or external storage devices via Internet, local area network, wide area network and/or wireless network. The network can comprise copper transmission cables, optical fiber transmission, wireless transmission, routers, firewalls, switches, gateway computers and/or edge servers. The network adapter or network interface in each computing/processing device receives computer-readable program instructions from the network, and forwards the computer-readable program instructions for storage in the computer-readable storage medium of each computing/processing device.

The computer program instructions for executing the operations of the present disclosure can be assembly instructions, instructions of instruction set architecture (ISA), machine instructions, machine-related instructions, microcodes, firmware instructions, state setting data, or a source code or target code written by any combinations of one or more programming languages comprising object-oriented programming languages, such as Smalltalk, C++ and so on, and conventional procedural programming languages, such as “C” language or similar programming languages. The computer-readable program instructions can be completely or partially executed on the user computer, or executed as an independent software package, or executed partially on the user computer and partially on the remote computer, or completely executed on the remote computer or the server. In the case where a remote computer is involved, the remote computer can be connected to the user computer by any type of networks, including local area network (LAN) or wide area network (WAN), or connected to an external computer (such as via Internet provided by the Internet service provider). In some embodiments, the electronic circuit is customized by using the state information of the computer-readable program instructions. The electronic circuit may be a programmable logic circuit, a field programmable gate array (FPGA) or a programmable logic array (PLA) for example. The electronic circuit can execute computer-readable program instructions to implement various aspects of the present disclosure.

Various aspects of the present disclosure are described in reference with the flow chart and/or block diagram of the method, device (system) and computer program product according to the embodiments of the present disclosure. It should be understood that each block in the flow chart and/or block diagram and any combinations of various blocks thereof can be implemented by the computer-readable program instructions.

The computer-readable program instructions can be provided to the processing unit of a general purpose computer, a dedicated computer or other programmable data processing devices to generate a machine, causing the instructions, when executed by the processing unit of the computer or other programmable data processing devices, to generate a device for implementing the functions/actions specified in one or more blocks of the flow chart and/or block diagram. The computer-readable program instructions can also be stored in the computer-readable storage medium. These instructions enable the computer, the programmable data processing device and/or other devices to operate in a particular way, such that the computer-readable medium storing instructions can comprise a manufactured article that includes instructions for implementing various aspects of the functions/actions specified in one or more blocks of the flow chart and/or block diagram.

The computer-readable program instructions can also be loaded into computers, other programmable data processing devices or other devices, so as to execute a series of operational steps on the computers, other programmable data processing devices or other devices to generate a computer implemented process. Therefore, the instructions executed on the computers, other programmable data processing devices or other devices can realize the functions/actions specified in one or more blocks of the flow chart and/or block diagram.

The accompanying flow chart and block diagram present possible architecture, functions and operations realized by the system, method and computer program product according to a plurality of embodiments of the present disclosure. At this point, each block in the flow chart or block diagram can represent a module, a program segment, or a portion of the instruction. The module, the program segment or the portion of the instruction includes one or more executable instructions for implementing specified logic functions. In some alternative implementations, the function indicated in the block can also occur in an order different from the one represented in the drawings. For example, two consecutive blocks actually can be executed in parallel, and sometimes they may also be executed in a reverse order depending on the involved functions. It should also be noted that each block in the block diagram and/or flow chart, and any combinations of the blocks thereof can be implemented by a dedicated hardware-based system for implementing specified functions or actions, or a combination of the dedicated hardware and the computer instructions.

Various embodiment of the present disclosure has been described above, and the above explanation is illustrative rather than exhaustive and is not limited to the disclosed embodiments. Without departing from the scope and spirit of each explained embodiment, many alterations and modifications are obvious for those ordinary skilled in the art. The selection of terms in the text aim to best explain principle, actual application or technical improvement in the market of each embodiment or make each embodiment disclosed in the text comprehensible for those ordinary skilled in the art.

I/We claim:

1. A method for managing index, comprising:
obtaining a first index term in a first index, the first index term corresponding to a first index content in the first index, the first index content indicating a position of the first index term in a document;
generating a reading of the first index term; and
adding the reading as a second index term into a second index, the reading corresponding to a second index content indicating the first index term.

2. The method according to claim 1, wherein the adding the reading as a second index term into a second index comprises:
in response to the reading matching an existing index term in the second index, appending the second index content indicating the first index term to the existing index term.

3. The method according to claim 1, wherein the adding the reading as a second index term into a second index comprises:
in response to the reading mismatching all existing index terms in the second index, creating the second index term and the second index content.

4. The method according to claim 1, wherein the second index excludes field information of the document.

5. The method according to claim 1, further comprising:
in response to a predefined condition related to the number of operations on the document being satisfied, re-creating the second index.

6. The method according to claim 1, further comprising:
generating a reading for a received query term;
in response to the reading of the query term matching a third index term in the second index, generating an expanded query term based on an index content corresponding to the third index term; and
performing a query on the first index by using the expanded query term.

7. An electronic device, comprising:
at least one processing unit; and
at least one memory coupled to the at least one processing unit and storing machine-executable instructions, the instructions, when executed by the at least one processing unit, performing acts including:
obtaining a first index term in a first index, the first index term corresponding to a first index content in the first index, the first index content indicating a position of the first index term in a document;
generating a reading of the first index term; and
adding the reading as a second index term into a second index, the reading corresponding to a second index content indicating the first index term.

8. The device of claim 7, wherein the adding the reading as a second index term into a second index comprises:
in response to the reading matching an existing index term in the second index, appending the second index content indicating the first index term to the existing index term.

9. The device of claim 7, wherein the adding the reading as a second index term into a second index comprises:
in response to the reading mismatching all existing index terms in the second index, creating the second index term and the second index content.

10. The device of claim 7, wherein the second index excludes field information of the document.

11. The device of claim 7, wherein the acts further include:
in response to a predefined condition related to the number of operations on the document being satisfied, re-creating the second index.

12. The device of claim 7, wherein the acts further include:
generating a reading for a received query term;
in response to the reading of the query term matching a third index term in the second index, generating an expanded query term based on an index content corresponding to the third index term; and
performing a query on the first index by using the expanded query term.

13. A computer program product for managing an index, the computer program product comprising:
a non-transitory computer readable medium encoded with computer-executable program code for managing the index, wherein the code is configured to enable the execution of:
obtaining a first index term in a first index, the first index term corresponding to a first index content in the first index, the first index content indicating a position of the first index term in a document;
generating a reading of the first index term; and
adding the reading as a second index term into a second index, the reading corresponding to a second index content indicating the first index term.

14. The computer program product according to claim 13, wherein the adding the reading as a second index term into a second index comprises:
in response to the reading matching an existing index term in the second index, appending the second index content indicating the first index term to the existing index term.

15. The computer program product according to claim 13, wherein the adding the reading as a second index term into a second index comprises:
in response to the reading mismatching all existing index terms in the second index, creating the second index term and the second index content.

16. The computer program product according to claim 13, wherein the second index excludes field information of the document.

17. The computer program product according to claim 13, wherein the code is further configured to enable the execution of:
in response to a predefined condition related to the number of operations on the document being satisfied, re-creating the second index.

18. The computer program product according to claim 13, wherein the code is further configured to enable the execution of:
generating a reading for a received query term;
in response to the reading of the query term matching a third index term in the second index, generating an expanded query term based on an index content corresponding to the third index term; and
performing a query on the first index by using the expanded query term.
